(19) United States
(12) Patent Application Publication
(10) Pub. No.: US 2010/0294087 A1
(43) Pub. Date: Nov. 25, 2010

(54) TOOL SLEEVE CLAMPING STRUCTURE

(75) Inventor: Cheng-tsan HU, TAINAN HSIEN (TW)

Correspondence Address: ROSENBERG, KLEIN & LEE, 3458 ELLICOTT CENTER DRIVE-SUITE 101, ELLICOTT CITY, MD, 21043, US

(73) Assignee: GONG FONG ENTERPRISE CO., LTD., TAINAN HSIEN (TW)

(21) Appl. No.: 12/469,044

(22) Filed: May 20, 2009

(51) Int. Cl. B25B 23/10

(52) U.S. Cl. 81/125

(57) ABSTRACT

A tool sleeve clamping structure includes a sleeve body and a clamp member. The sleeve body includes a socket at one end thereof and a blind hole therein. The socket has a chamber therein. The blind hole interconnects with the chamber. The chamber has a plurality of inner side walls, a pair of engaging recesses at two opposing inner side walls, and a plurality of positioning portions each disposed between every two of the inner side walls. The clamping member secured in the chamber of the sleeve body has at least two engaging sections, a through hole corresponding in position to the blind hole, and a plurality of protrusions. The two engaging sections engage with the pair of engaging recesses. The pair of engaging sections is provided with resilient plates for clamping a nut. Each of the protrusions is formed by the intersection of every two adjacent sides of the clamping member.

### BACKGROUND OF THE INVENTION

1. Field of the Invention

The present invention relates to a tool sleeve clamping structure, and more particularly to one having a clamping member located in a chamber. The clamping member has protrusions extending outwardly. The protrusions are secured in positioning portions of the chamber. The clamping member further comprises resilient plates to clamp a nut or a tool head for locking or loosening the nut or a screw.

2. Description of the Prior Art

Nuts are commonly used for fastening in machinery assembly. But it requires more time and labor to have the job done if it is performed only by hands and a wrench. For better work efficiency, a sleeve is usually utilized to facilitate the fastening and releasing process. As shown in FIG. 7, a conventional sleeve A comprises a connecting rod A1 at one end for connection of a wrench. The sleeve A has a hexagonal chamber A2 for insertion of a nut B. The nut B is screwed to a screw or a bolt by means of the sleeve A. However, without a fixing mechanism in the chamber A2, the nut B might drop during the working process, which causes great inconvenience to the assembly. On the other hand, the bottom of the chamber A2 of the socket A is closed, if the length of the bolt is greater than the depth of the chamber A2, the sleeve A has to be removed and another tool, such as an open spanner or an adjustable spanner, will has to be used to complete the job.

### SUMMARY OF THE INVENTION

The present invention is to overcome the aforesaid shortcomings. According to the present invention, there is provided a tool sleeve clamping structure, comprising a sleeve body having a connecting portion at a first end and a socket at a second end thereof, the socket having a chamber therein, the sleeve body further having a blind hole therein, the blind hole interconnecting with the chamber, the chamber having a plurality of inner side walls, a pair of engaging recesses at two opposing inner side walls, and a plurality of positioning portions each disposed between every two of the inner side walls; and a clamping member secured in the chamber of the sleeve body, the clamping member comprising at least two engaging sections on a circumferential portion, a through hole corresponding in position to the blind hole of the sleeve body, and a plurality of protrusions, the two engaging sections engaging with the pair of engaging recesses of the chamber, the pair of engaging sections being provided with resilient plates extending from the engaging sections, each of the protrusions being formed by the intersection of every two adjacent sides of the clamping member.

Preferably, the clamping member corresponds in shape to the chamber.

Preferably, the blind hole has a diameter smaller than a diameter of the chamber.

Preferably, each of the resilient plates has a curved shape.

Preferably, the positioning portions are positioning grooves.

It is the primary object of the present invention to provide a tool sleeve clamping structure, which uses resilient plates to secure a nut and prevent the nut from dropping, and which can be handled by a single hand.

It is another object of the present invention to provide a tool sleeve clamping structure, which provides a clamping member with protrusions extending outwardly to secure a nut in the chamber.

It is a further object of the present invention to provide a tool sleeve clamping structure, which has a blind hole in a sleeve body for a bolt with an exceeded portion to be inserted therein, without changing another tool to lock the nut on a bolt.

It is still a further object of the present invention to provide a tool sleeve clamping structure, which uses resilient plates to hold a tool head or a driver head for rotating the sleeve body to tighten or loosen a screw.

### BRIEF DESCRIPTION OF THE DRAWINGS

FIG. 1 is an exploded view of a first preferred embodiment of the present invention;

FIG. 2 is a partially sectional view of the first preferred embodiment of the present invention;

FIG. 3 is a front sectional view of the first preferred embodiment of the present invention;

FIG. 4 is a sectional view showing a nut held by a clamping member of the first preferred embodiment of the present invention;

FIG. 5 is a sectional view showing the nut screwed on a long bolt of the first preferred embodiment of the present invention;

FIG. 6 is a sectional view of a second preferred embodiment of the present invention; and

FIG. 7 is a cross-sectional view of the prior art.

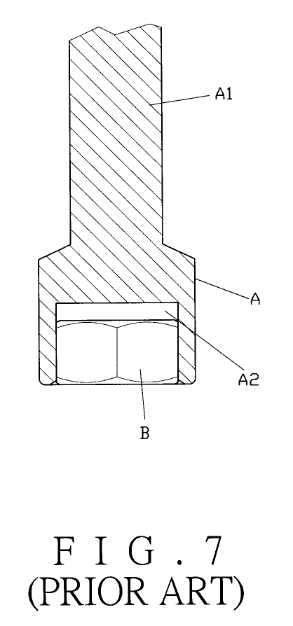

### DETAILED DESCRIPTION OF THE PREFERRED EMBODIMENTS

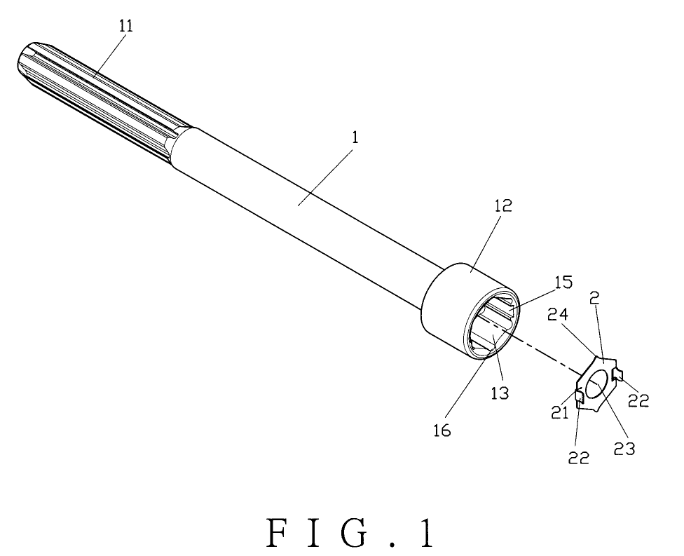

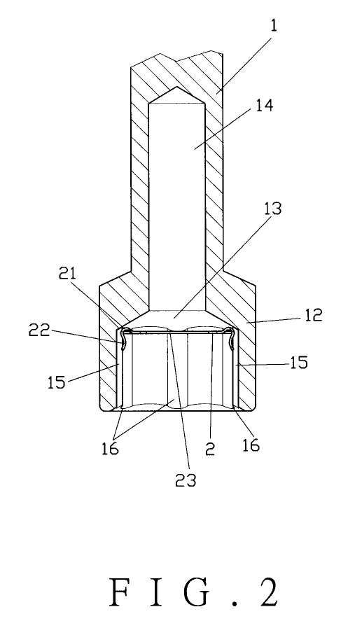

A tool sleeve clamping structure of a first preferred embodiment of the present invention, as shown in FIGS. 1 and 2, comprises a sleeve body 1 and a clamping member 2.

The sleeve body 1 comprises a connecting portion 11 at a first end and a socket 12 at a second end thereof. The socket 12 has a non-circular chamber 13. In this embodiment, the chamber 13 is in a hexagonal shape. The sleeve body 1 further has a blind hole 14 therein. The blind hole 14 is interconnected with the chamber 13. The blind hole 14 has a diameter smaller than that of the chamber 13. The chamber 13 has a plurality of inner side walls, a pair of engaging recesses 15 at two opposing inner side walls, and a plurality of positioning portions 16 each disposed between every two of the inner side walls. The positioning portions 16 are positioning grooves.

The clamping member 2 is secured in the chamber 13 of the sleeve body 1. The clamping chamber 2 corresponds in shape to the chamber 13, and comprises at least two engaging sections 21 on a circumferential portion thereof. The two engaging sections 21 engage with the pair of engaging recesses 15 of the chamber 13. Each of the pair of engaging sections 21 is provided with a curved resilient plate 22 extending from the engaging section 21 for providing a clamping force. The clamping member 2 has a through hole 23 corresponding in position to the blind hole 14 and a plurality of protrusions 24. Each of the protrusions 24 is formed by the intersection of every two adjacent sides of the clamping member 2.

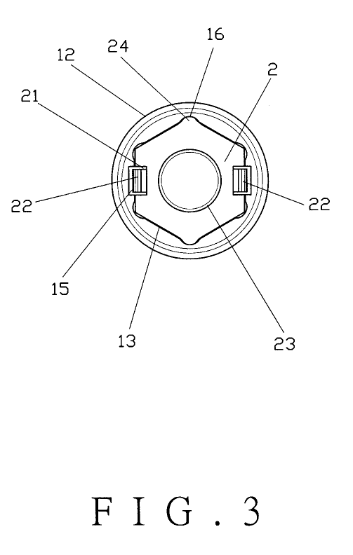

To assemble the present invention, as shown in FIGS. 2 and 3, the clamping member 2 is placed into the chamber 13 of the sleeve body 1 with the two engaging sections 21 sliding along the pair of engaging recesses 15 of the chamber 13. When the clamping member 2 engages with the inner side walls of the chamber 13, the protrusions 24 will be compressed by the inner side walls of the chamber 13 to be in a hook-like shape and secured in the positioning portions 16 so that the clamping member 2 is fixed in the chamber 13.

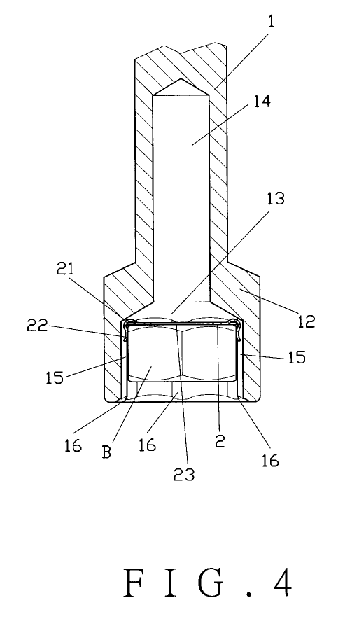

When in use, as shown in FIG. 4, a nut B is placed into the chamber 13 of the sleeve body 1, with the two resilient plates 22 of the clamping member 2 holding the nut B resiliently. When the nut B is moved to a place where a bolt or a screw is, the nut B will be securely held in the chamber 13 by the resilient plates 22, preventing the nut B from dropping. The present invention can be operated with a single hand.

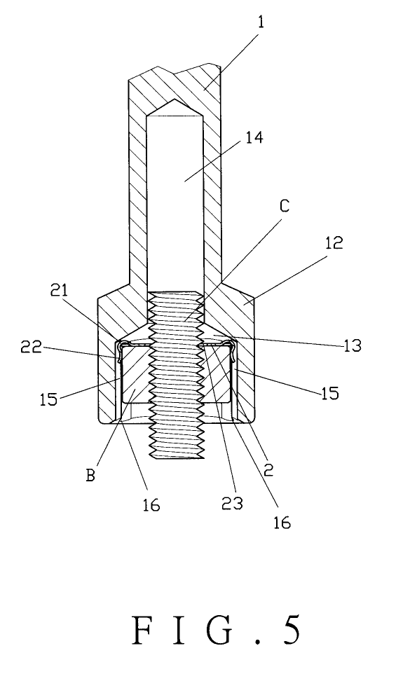

To tighten the nut B on a bolt C, as shown in FIG. 5, the connecting portion 11 of the sleeve body 1 can be connected with a wrench (not shown in the drawings) for facilitating the locking procedure. While tightening, if the length of the bolt C is greater than the depth of the chamber 13, the exceeded portion of the bolt C will extend into the blind hole 14 of the sleeve body 1 through the through hole 23 of the clamping member 2 till the nut B is fully tightened on the bolt C, without using another tool to finish the job.

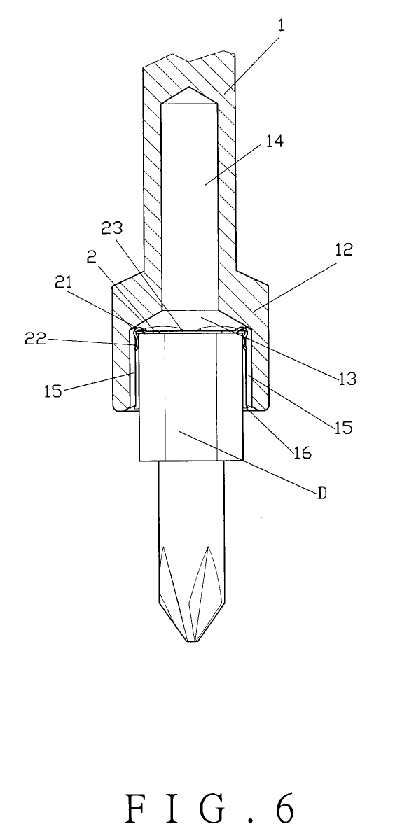

FIG. 6 is a second preferred embodiment of the present invention, which is substantially similar to the first preferred embodiment with the exceptions described hereinafter. A tool head D is provided in the chamber 13 of the socket 12, with the resilient plates 22 of the clamping member 2 holding the tool head D resiliently. In this embodiment, the tool head D may be a screwdriver head. The sleeve body 1 is rotated to tighten or loosen a screw.

What is claimed is:

1. A tool sleeve clamping structure, comprising:
a sleeve body, comprising a connecting portion at a first end and a socket at a second end thereof, the socket having a chamber therein, the sleeve body further having a blind hole therein, the blind hole interconnecting with the chamber, the chamber having a plurality of inner side walls, a pair of engaging recesses at two opposing inner side walls, and a plurality of positioning portions each disposed between every two of the inner side walls; and
a clamping member secured in the chamber of the sleeve body, the clamping member comprising at least two engaging sections on a circumferential portion, a through hole corresponding in position to the blind hole of the sleeve body, and a plurality of protrusions, the two engaging sections engaging with the pair of engaging recesses of the chamber, the pair of engaging sections being provided with resilient plates extending from the engaging sections, each of the protrusions being formed by the intersection of every two adjacent sides of the clamping member.

2. The tool sleeve clamping structure as recited in claim 1, wherein the clamping member corresponds in shape to the chamber.

3. The tool sleeve clamping structure as recited in claim 1, wherein the blind hole has a diameter smaller than a diameter of the chamber.

4. The tool sleeve clamping structure as recited in claim 1, wherein each of the resilient plates has a curved shape.

5. The tool sleeve clamping structure as recited in claim 1, wherein the positioning portions are positioning grooves.
